(19) United States
(12) Patent Application Publication
(10) Pub. No.: US 2026/0017019 A1
(43) Pub. Date: Jan. 15, 2026

(54) HIGH PRECISION COMPLEX NUMBER BASED ROTARY POSITIONAL ENCODING CALCULATION ON 8-BIT COMPUTE HARDWARE

(71) Applicant: Tesla, Inc., Austin, TX (US)

(72) Inventors: Hasan UNLU, Mountain View, CA (US); Ritvik RAWAT, Sunnyvale, CA (US); Rohan DHESIKAN, Mountain View, CA (US); Srihari SADHU SAMPATHKUMAR, Palo Alto, CA (US); Alex Nihal SINGH, Palo Alto, CA (US)

(73) Assignee: Tesla, Inc., Austin, TX (US)

(21) Appl. No.: 19/259,760

(22) Filed: Jul. 3, 2025

Related U.S. Application Data
(60) Provisional application No. 63/669,080, filed on Jul. 9, 2024.

(51) Int. Cl. G06F 7/523; G06F 7/50

(52) U.S. Cl. CPC G06F 7/523; G06F 7/50

(57) ABSTRACT

Embodiments include systems and methods for rotary positional embedding in a mixed-precision pipeline. An example method can be performed in a mixed-precision pipeline including a multiplier-accumulator (MAC) for a first bit width to execute a multiplication function and a logic execution block for a second, greater, bit width. The method includes operations executed by the circuit including obtaining, via a circuit for a first bit-width, an input tensor and a logarithm of an angle, θ; generating, by a multiplication function for inputs having the first bit-width, a product of a first element of the input tensor and a first element of the logarithm of θ, each of the first elements having the first bit-width. The method includes operations executed by the logic execution block including generating an exponent of the product to determine θ according to the second bit-width and generating a rotation matrix according to trigonometric functions of θ.

### CROSS REFERENCE TO RELATED APPLICATION

This application claims priority to U.S. Provisional Patent Application No. 63/669,080, filed Jul. 9, 2024, which is incorporated herein by reference in its entirety and for all purposes.

### TECHNICAL FIELD

This disclosure relates generally to augmenting an effective number of bits for a hardware pipeline. For example, the bit augmentation can be realized for multiplier-accumulators in a machine learning implementation.

### BACKGROUND

Convolutional neural networks (CNNs) were one of the earliest and most significant type of machine learning network, especially in the domain of computer vision. In recent years, machine learning has undergone a meteoric rise, revolutionized industries, and reshaped the technological landscape. Breakthroughs in architecture methodologies, including deep learning, have led to unprecedented levels of performance in tasks such as image recognition/computer vision, natural language processing, and autonomous driving. However, the increased precision of such approaches can prove expensive in terms of power budgets, die area, and other design considerations.

Moreover, a product lifecycle for some goods including graphics processing units (GPU), automobiles, robotics, and so forth, can span decades-several generations of algorithmic development. Even where such products include substantial computational headroom to support updated algorithms, the types of hardware accelerators used may evolve over time, leading to mismatches between a type of hardware in a deployed product and the components which may be associated with an updated model. Improvements in the art are desired.

### SUMMARY

Processing units of circuits may receive and analyze position data to determine or encode position information as an output. The position information of a circuit may include relative and/or absolute position information and may indicate, for example, a position of an ego vehicle associated with the circuit, or other device or object comprising the circuit, such as an autonomous vehicle or mobile device. The circuit processing unit of the circuit and the position information may reflect or depend on various levels or degrees of precision. Generally, higher-precision position data requires more data-processing capabilities of the circuit compared to lower-precision position data. However, some operations can be performed using bit-widths wider than the fixed bit-width of a MAC or other circuit component. Data used in these operations is sometimes referred to as bit-augmented data. For example, a data bus operatively coupled with the MAC can provide data at lower degrees of precision achievable by other circuit components. Such an approach can be applied to achieve increased precision from lower precision hardware components, or can be used in new designs.

In some circumstances, the higher-precision position data might exceed or overly-burden the capabilities of previously deployed hardware and circuits. Moreover, because absolute position information does not convey relative location or context, such absolute position information often uses more data processing to provide contextually useful analysis. For example, many implementations of convolutional neural networks (CNNs) have been supplemented with higher resolution CNNs, transformer models, attention mechanisms, or other implementations which can use varying hardware resources or bit-precision (e.g., lesser or greater precision, such as by replacing an 8-bit dataflow with a 16-bit data flow). Accordingly, compute devices tasked with implementing newer techniques may not only suffer from a lack of some hardware components, the compute devices can also include components that are underutilized according to updated models.

Further, inclusion of lower bit-width hardware (e.g., buses, processor cores, memory) in new designs can reduce power consumption according to a reduced number of signal state transitions or reduced size and power of bus drivers. The lower bit-width can also reduce circuit area used for routing (or increase line-to-line spacing to improve signal integrity) and may reduce an interconnect density in multi-chip modules, or between functional blocks of a monolithic device. This reduction in power usage or circuit area can exceed the power usage or circuit area used by a MAC. Moreover, even where the inclusion of the MAC leads to a net increase in area or power, the MAC can be placed away from density-critical areas or thermal hot spots, leading to overall improvement to device thermals, die area, or so forth. Further still, application of the techniques of the present disclosure can aid in the re-use of an existing computing device for higher precision data than originally intended.

Embodiments described herein including circuit hardware capable of operating a pipeline of varied or mixed-precision position information. The hardware components described herein implement Rotary Positional Embedding (RoPE) to output rotary positional embeddings or vectors that encode or represent position information as relative position information. In some implementations, the processing unit may implement certain types of geographic or geometric functions (e.g., trigonometric functions) in a high-precision domain, but implement other functions in a low-precision domain (e.g., data storage functions, data transfer functions).

In some embodiments, a method for encoding position information in a mixed-precision pipeline may include obtaining, via a circuit for a first bit-width, an input tensor and a logarithm of an angle, θ; generating, by a multiplication function of the circuit for inputs having the first bit-width, a product of a first element of the input tensor and a first element of the logarithm of the angle θ, each of the first elements having the first bit-width; generating, via a logic execution block having a second bit-width greater than the first bit-width, an exponent of the product to determine the logarithm of the angle θ according to the second bit-width; generating, via the logic execution block, a rotation matrix according to trigonometric functions of the logarithm of the angle, θ; and updating, via the logic execution block, positional information of tokens for the circuit based upon the rotation matrix and one or more elements of the input tensor.

The method may further include generating, using the multiplication function of the circuit, a product of a second element of the input tensor and a second element of the logarithm of the logarithm of the angle θ, each of the second elements having the first bit-width. The method may further include obtaining, from a storage location for pre-computed values, the first element and second element of the logarithm of the angle, θ.

The method may further include generating, based on the first element of the input tensor and the rotation matrix, transformed coordinates. The method may further include storing the transformed coordinates at a storage location. The storage location may be read-accessible to a component of a data pipeline and the component may be disposed downstream of a MAC implementing the multiplication function and the logic execution block. The storage location may not be read-accessible by the logic execution block, and is not write-accessible by the downstream component.

The method may further include encoding positional information of tokens into input embeddings of a transformer model based on the rotation matrix. The multiplication function may be a hardware-limited fixed-bit function of a multiplier-accumulator (MAC). The pre-computed value of the logarithm of the angle θ may be stored according to a greater bit-width than the MAC and a lesser bit-width than the logic execution block.

In some embodiments, a system for encoding position information in a mixed-precision pipeline may include a circuit and a logic execution block. The circuit for a first bit-width and may be configured to: execute a multiplication function for inputs having the first bit-width; obtain a first set of values and a second set of values; and generate, using the multiplication function, a product of a first element of the first set of values and a first element of the second set of values, each of the first elements having the first bit-width. The logic execution block having a second bit-width greater than the first bit-width, may be configured to: generate an exponent of the product to determine an output according to the second bit-width; and generate output data based on the exponent of the product.

The system may be for encoding position information in a mixed-precision pipeline. The circuit may be configured to: generate, using the multiplication function, a product of a second element of an input tensor and a second element of a logarithm θ, each of the second elements having the first bit-width; generate an exponent of the product to determine the logarithm e according to the second bit-width; generate a rotation matrix according to trigonometric functions of the logarithm θ; and update positional information for the circuit based upon the rotation matrix and one or more elements of the input tensor. The first set of values may include the input tensor and the second set of values include the logarithm of the logarithm θ. The system may be configured to provide, from a storage location for pre-computed values and to the circuit, the first element and second element of the logarithm θ.

The ALU may be configured to generate, based on the first element of the input tensor and the rotation matrix, transformed coordinates. The ALU may be configured to store the transformed coordinates at a storage location, the storage location read-accessible to a component of a data pipeline, the component disposed downstream of both a multiplier-accumulator (MAC) implementing the multiplication function and the ALU.

The storage location may not be read-accessible by the ALU, and may not be write-accessible by the downstream component. The system may be configured to generate, using the rotation matrix, input embeddings of a transformer model including positional information. The multiplication function may be a hardware-limited fixed-bit function of a multiplier-accumulator (MAC). The multiplication function may be configured to generate products having the second bit-width from first second multiplicands having the first bit-width.

In some embodiments, an autonomous vehicle may include one or more sensors, a circuit, and a logic execution block. The one or more sensors may be configured to generate an input data structure having a plurality of data elements which exceed a first bit-width and are equal to a second bit-width, and includes natural numbers. The circuit for the first bit-width and may be configured to: execute a multiplication function for inputs having the first bit-width; obtain an input tensor and a logarithm of an angle, θ; and generate, using the multiplication function, a product of a first element of the input tensor and a first element of the logarithm of the angle θ, each of the first elements having the first bit-width. The logic execution block having the second bit-width greater than the first bit-width and may be configured to: generate an exponent of the product to determine the logarithm of the angle θ according to the second bit-width; and generate a rotation matrix according to trigonometric functions of the logarithm of the angle θ.

The circuit may be configured to generate, using the multiplication function, a product of a second element of the input tensor and a second element of the logarithm θ, each of the second elements having the first bit-width. The ALU may be configured to generate, based on the first element of the input tensor and the rotation matrix, transformed coordinates.

The ALU may be configured to store the transformed coordinates at a storage location, the storage location read-accessible to a component of a data pipeline, the component disposed downstream of both: a multiplier-accumulator (MAC) implementing the multiplication function, and the ALU. The storage location may not be read-accessible by the ALU, and may not be write-accessible by the downstream component.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates components of an AI-enabled visual data analysis system for egos, according to an embodiment.

FIG. 1B illustrates various sensors associated with vehicle (or other type of ego), according to an embodiment.

FIG. 1C illustrates the components of an ego, according to an embodiment.

FIG. 1D shows certain hardware and software components of the ego for performing full or partial self-driving (SD) operations, according to an embodiment.

FIG. 2 illustrates a block diagram of an example of a circuit for mixed-precision rotary position embedding, according to some embodiments.

FIG. 3 illustrates a block diagram of a circuit for a low-precision portion of a circuit for rotary position embedding, according to some embodiments.

FIG. 4 illustrates a block diagram of a high-precision portion of a circuit for rotary position embedding, according to some embodiments.

FIG. 5 illustrates an example of a method for rotary position embedding, according to some embodiments.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

Embodiments described herein include systems and methods related to bit augmented arithmetic convolution. A transformer model, convolutional neural network (CNN), or other aspect of a machine learning architecture can be executed according to many parallel multiplier-accumulators (MACs). However, when implemented in hardware, such as in the case of an application-specific integrated circuit (ASIC), a MAC can include a predefined bit width, corresponding to a data path of a design architecture. Further, as indicated above, the use of reduced-bit data paths can reduce power use, die area, mutual interferences, and so forth. Accordingly, it may be challenging to process higher resolution data than an ASIC or other forms of hardware circuit was originally designed for. However, according to the present disclosure, convolutional processes (e.g., as implanted by MAC blocks) can be used to generate updated data flows for higher resolution or other updated models. In some embodiments, the systems and methods disclosed herein can be implemented at a compiler or a low-level of a stack such that the particular hardware implementation may be realized transparently to a model or other application-level software. For example, the systems realized according to the present disclosure can operate at a same precision, data throughout, or performance as native hardware mated with models involving larger bit widths than are available in a MAC or other hardware component, in some embodiments.

The circuit may receive and analyze various types of data indicating or containing information of the circuit or other hardware component or object (e.g., machine vision or autonomous vehicle functions). For example, the data can include environmental information for an environment including an ego vehicle, robot, or other system. For example, the environmental information can include audio data or visual data (e.g., positional information). The data can include Positional information which may include relative position information or absolute position information and may be represented in software and the various data formats as embeddings or vectors. The software and hardware components of the embodiments described herein may obtain input data containing position information, and may generate the embeddings or vectors that encode or represent the position information. Audio data can include information received from a microphone configured to receive audio data from an exterior of the ego vehicle or other system. For example, the audio data can include information indicative of emergency vehicle sirens, horns, collisions, or so forth. Position data can include data as captured by sensors (e.g., microphones, cameras, or radars), or various transforms of the sensor data. For example, the position data can include data elements corresponding to an intermediate representation of an environment, such as a 3D map, birds eye-view, or so forth. Some intermediate representations can include non-spatial constructs generated according to some computing systems. These intermediate representations can include data from one or more sensors (e.g., fused sensor maps).

The positional information can be encoded according to Rotary Positional Embedding (RoPE) using the positional information of input tokens. The output of ROPE may include rotary positional embeddings or vectors that encode positional data (e.g., paired X-Y set of coordinates in a coordinate plane). For example, hardware components having a fixed bit-width can be used to encode the information for a transformer model. Unlike positional embeddings that add fixed positional encodings to input embeddings, RoPE uses a rotary position embedding including a rotation matrix to encode relative positions. This maintains an inner product between embeddings, preserving the relative distance information, which helps the model better capture sequential relationships and improve the ability to generalize to different sequence lengths. However, the rotational positions are calculated according to sine and cosine calculations which can suffer from relatively high data loss from lower precision data. For example, a rotation matrix, R₀ for an angle θ can be defined according to

$$\begin{matrix}cos ( θ ) & - sin ( θ ) \\ sin ( θ ) & cos ( θ )\end{matrix} .$$

Determining such a rotation according to lower precision (e.g., eight-or sixteen-bit data) can lead to substantial quantization errors, which can compound according to repeated rotations (e.g., within a complex plane).

Even where higher precision compute may be available in an arithmetic logic unit (ALU), computational operations performed with respect to an input vector or tensor may lead to a loss of precision at hardware corresponding to the vector or tensor. For example, operations performed at an eight-bit MAC block can lead to accumulation of later error. Moreover, a hardware pipeline may not be configured, natively, to transport larger-bit values. For example, implementing thirty-two-bit precision in a memory location configured to store sixteen-bit precision data can store half as many values, can reduce a number of stored values, or a data bus may not be configured to exchange data at a throughout for the larger values at all. Accordingly, it may be advantageous to perform a first subset of operations in a lower precision domain and a second subset of operations in a higher precision domain. For example, by initially operating based on a log of a value rather than the value itself (in a low-precision domain), and later restoring the value via an exponent in a higher precision domain, higher overall precision can be maintained, even where such operations taken alone lead to quantifiable discretization error. For example, where the data is stored according to a same bit-width in either case (e.g., sixteen-bits), the log may exhibit lower dynamic range so as to lower associated discretization error, according to some integer or formats (e.g., floating point formats). Bit-padding can be applied to operate according to various further bit values (e.g., twelve bits, twenty bits, or so on).

By using an input value exceeding a width of a MAC (e.g., a sixteen-bit value for an eight-bit MAC) and alternating between an upper and lower byte of the value, discretization error can be mitigated. Further, by using a non-linear value, such as a logarithm (e.g., log10, log2, 1n, etc.) of theta (θ) rather than theta itself, discretization errors can further be reduced. For example, a MAC can be provided with a vector or tensor inputs of X₁₁, Y₁₁, X₁₂, Y₁₂ . . . for convolution with a logarithm of θ (e.g., precalculated values retrievable via lookup). The MAC (e.g., an eight-bit MAC) can obtain the inputs for provision to a higher precision ALU (e.g., a thirty-two bit ALU). For example, the MAC can execute a multiplication function (e.g., a fixed-bit function) to input valuers to an adder, accumulator, or other output register by multiplying the values by one or by another value to left-shift a value into a position within the output word (e.g., where the output word exhibits larger bit-width than the input of the MAC). In some cases, the multiplication function is a hardware-limited fixed-bit function of the MAC or other hardware components.

The ALU can, in turn, generate X′ and Y′ values according to higher precision hardware. For example, the ALU can extract a value of theta according to an exponentiation to negate the previously applied logarithm. The ALU can further calculate sine and cosine values in high-precision (e.g., according to a Taylor-series expansion), and introduce the values into the previously described rotation matrix, R₀ which, when multiplied with input values X and Y, can generate X′ and Y′ which may be stored or conveyed to further pipeline elements. References to an ALU can refer to logic blocks configured to operate on input data and instructions. Such ALU can include, but are not limited to, a processor core. For example, a GPU execution unit or other logic execution block of an ASIC can be referred to as an ALU, without limiting effect.

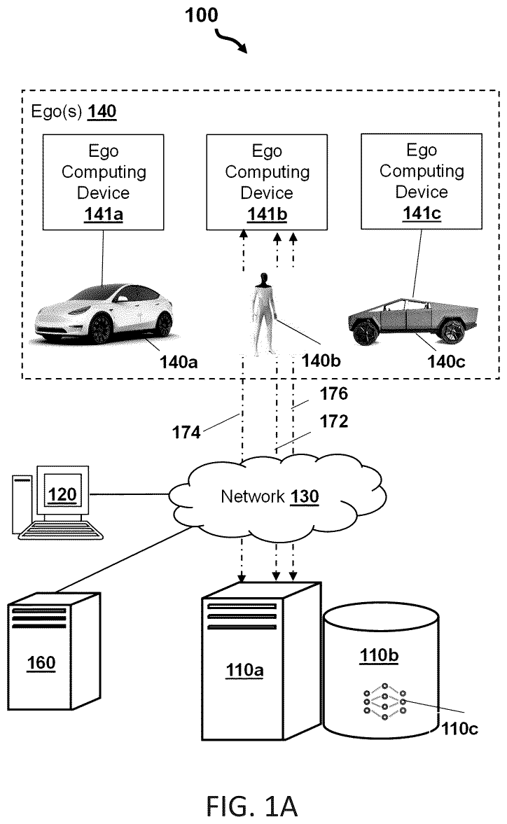

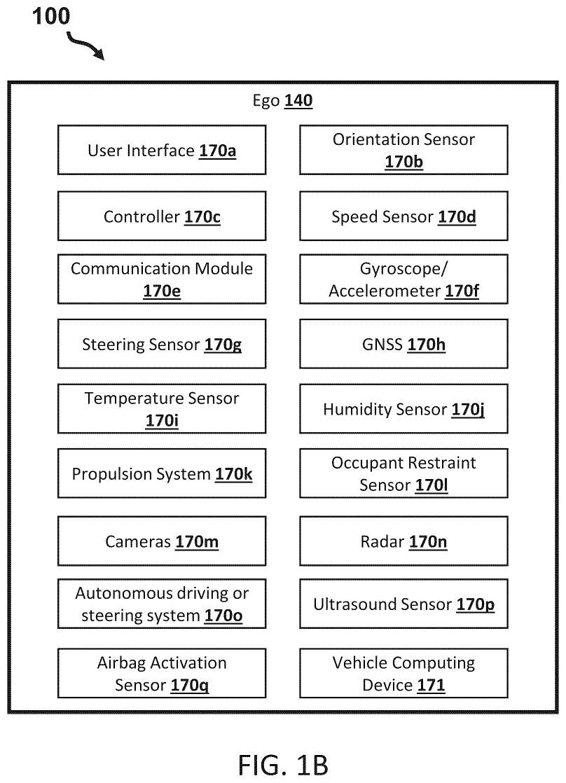

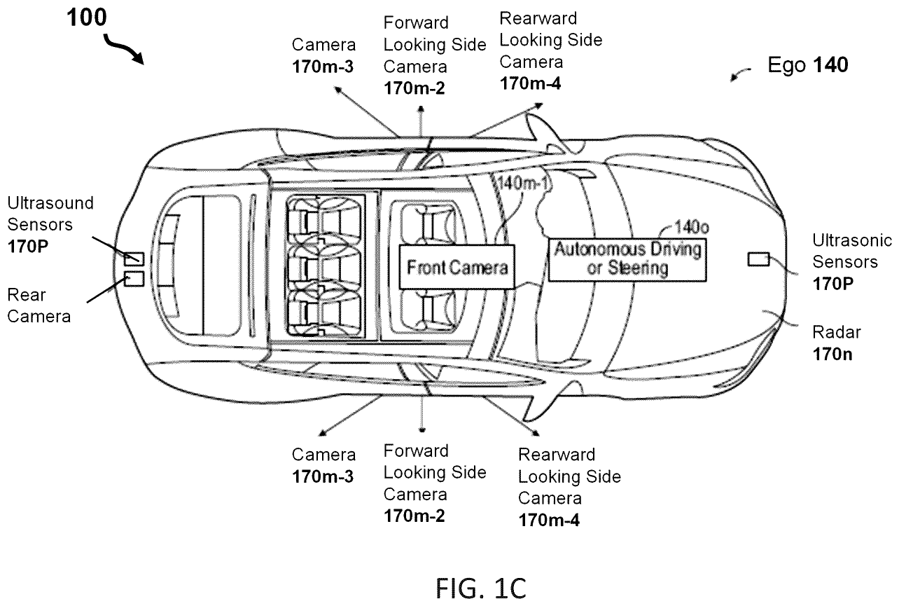

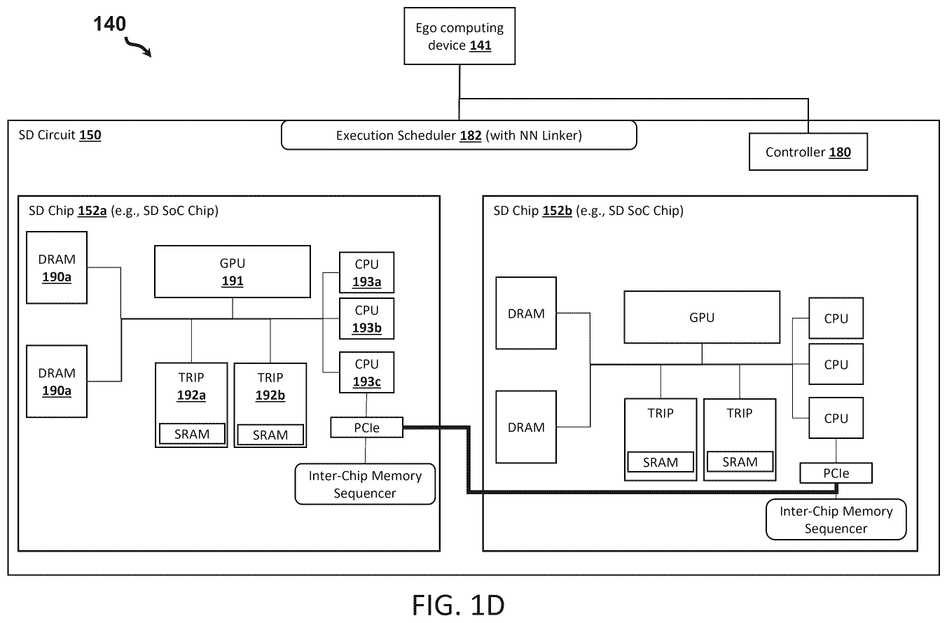

FIG. 1A is a non-limiting example of components of a system 100 in which the methods and systems discussed herein can be implemented. For instance, an analytics server may train an AI model and use the trained AI model to generate an occupancy dataset and/or other representation of an environment (sometimes referred to as an occupancy map, world model, perception output, or so forth) for one or more egos. FIG. 1A illustrates components of an AI-enabled visual data analysis system 100. The system 100 may include an analytics server 110a, a system database 110b, an administrator computing device 120, egos 140a-b (collectively ego(s) 140), ego computing devices 141a-141c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 174). When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may determine the occupancy status of its surroundings (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received the egos 140 can be used to at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased by a consumer and the purpose of the trip may be categorized as everyday use. The navigation session may start when the egos 140 move from a non-moving position beyond a threshold distance (e.g., 0.1 mi, 100 ft) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-1C illustrate block diagrams of sensors integrated within the egos 140, according to an embodiment. The number and position of each sensor discussed with respect to FIGS. 1B-1C may depend on the type of ego 140 discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 1700). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140, and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 170l may monitor seatbelt detection and locking/unlocking assemblies, as well as other passenger restraint subsystems. The occupant restraint sensor 170l may include various environmental and/or status sensors, actuators, and/or other devices facilitating the operation of safety mechanisms associated with the operation of the egos 140. For example, occupant restraint sensor 170l may be configured to receive motion and/or status data from other sensors depicted in FIG. 1B. The occupant restraint sensor 170l may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior-or exterior-facing cameras of the egos 140. For instance, as depicted in FIG. 1C, the egos 140 may include one or more interior-facing cameras that may monitor and collect footage of the occupants of the egos 140. The egos 140 may include eight exterior facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

Referring to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 170ₒ configured to use data collected via various sensors (e.g., radar 170n, speed sensor 170d, and/or ultrasound sensors 170p) to autonomously navigate the ego 140.

Therefore, autonomous driving or steering system 170ₒ may analyze various data collected by one or more sensors described herein to identify driving data. For instance, autonomous driving or steering system 170ₒ may calculate a risk of forward collision based on the speed of the ego 140 and its distance to another vehicle on the road. The autonomous driving or steering system 170ₒ may also determine whether the driver is touching the steering wheel. The autonomous driving or steering system 170ₒ may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-1C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of how the AI model(s) 110c can be trained, the analytics server 110a may collect data from egos 140 to train the AI model(s) 110c. Before executing the AI model(s) 110c to generate/predict an occupancy dataset, the analytics server 110a may train the AI model(s) 110c using various methods. The training allows the AI model(s) 110c to ingest data from one or more cameras of one or more egos 140 (without the need to receive radar data) and predict occupancy data for the ego's surroundings. The operation described in this example may be executed by any number of computing devices operating in the distributed computing system described in FIGS. 1A-1D (e.g., a processor of the egos 140).

The analytics server 110a may generate, using a sensor of an ego 140, a first dataset having a first set of data points where each data point within the first set of data points corresponds to a location and a sensor attribute of at least one voxel of space around the egos 140, the sensor attribute indicating whether the at least one voxel is occupied by an object having mass.

To train the AI model(s) 110c, the analytics server 110a may first employ one or more of the egos 140 to drive a particular route. While driving, the egos 140 may use one or more of their sensors (including one or more cameras) to generate navigation session data. For instance, the one or more of the egos 140 equipped with various sensors can navigate the designated route. As the one or more of the egos 140 traverse the terrain, their sensors may capture continuous (or periodic) data of their surroundings. The sensors may indicate an occupancy status of the one or more egos' 140 surroundings. For instance, the sensor data may indicate various objects having mass in the surroundings of the one or more of the egos 140 as they navigate their route.

The analytics server 110a may generate a first dataset using the sensor data received from the one or more of the egos 140. The first dataset may indicate the occupancy status of different voxels within the surroundings of the one or more of the egos 140. As used herein in some embodiments, a voxel is a three-dimensional pixel, forming a building block of the surroundings of the one or more of the egos 140. Within the first dataset, each voxel may encapsulate sensor data indicating whether a mass was identified for that particular voxel. Mass, as used herein, may indicate or represent any object identified using the sensor. For instance, in some embodiments, the egos 140 may be equipped with an emitter that identifies a mass by emitting pulses and measuring the time it takes for these pulses to travel to an object (having mass) and back. These sensor systems may operate based on the principle of measuring the distance between the emitter/sensor and objects in its field of view. This information, combined with other sensor data, may be analyzed to identify and characterize different masses or objects within the surroundings of the one or more of the egos 140.

Various additional data may be used to indicate whether a voxel of the one or more egos' 140 surroundings is occupied by an object having mass or not. For instance, in some embodiments, a digital map of the surroundings (e.g., a digital map of the route being traversed by the ego) of the one or more egos 140 may be used to determine the occupancy status of each voxel.

In operation, as the one or more egos 140 navigate, their sensors collect data and transmit the data to the analytics server 110a, as depicted in the data stream 176. For instance, the ego 140 computing devices 141 may transmit sensor data to the analytics server 110a using the data stream 176.

The analytics server 110a may generate, using a camera of the ego 140, a second dataset having a second set of data points where each data point within the second set of data points corresponds to a location and an image attribute of at least one voxel of space around the ego 140.

The analytics server 110a may receive a camera feed of the one or more egos 140 navigating the same route as in the first step. In some embodiments, the analytics server 110a may simultaneously (or contemporaneously) perform the first step and the second step. Alternatively, two (or more) different egos 140 may navigate the same route where one ego transmits its sensor data, and the second ego 140 transmits its camera feed.

The one or more egos 140 may include one or more high-resolution cameras that capture a continuous stream of visual data from the surroundings of the one or more egos 140 as the one or more egos 140 navigate through the route. The analytics server 110a may then generate a second dataset using the camera feed where visual elements/depictions of different voxels of the one or more egos' 140 surroundings are included within the second dataset.

In operation, as the one or more egos 140 navigate, their cameras collect data and transmit the data to the analytics server 110a, as depicted in the data stream 172. For instance, the ego computing devices 141 may transmit image data to the analytics server 110a using the data stream 172.

The analytics server 110a may train an AI model using the first and second datasets, whereby the AI model 110c correlates each data point within the first set of data points with a corresponding data point within the second set of data points, using each data point's respective location to train itself, wherein, once trained, the AI model 110c is configured to receive a camera feed from a new ego 140 and predict an occupancy status of at least one voxel of the camera feed.

Using the first and second datasets, the analytics server 110a may train the AI model(s) 110c, such that the AI model(s) 110c may correlate different visual attributes of a voxel (within the camera feed within the second dataset) to an occupancy status of that voxel (within the first dataset). In this way, once trained, the AI model(s) 110c may receive a camera feed (e.g., from a new ego 140) without receiving sensor data and then determine each voxel's occupancy status for the new ego 140.

The analytics server 110a may generate a training dataset that includes the first and second datasets. The analytics server 110a may use the first dataset as ground truth. For instance, the first dataset may indicate the different location of voxels and their occupancy status. The second dataset may include a visual (e.g., a camera feed) illustration of the same voxel. Using the first dataset, the analytics server 110a may label the data, such that data record(s) associated with each voxel corresponding to an object are indicated as having a positive occupancy status.

The labeling of the occupancy status of different voxels may be performed automatically and/or manually. For instance, in some embodiments, the analytics server 110a may use human reviewers to label the data. For instance, as discussed herein, the camera feed from one or more cameras of a vehicle may be shown on an electronic platform to a human reviewer for labeling. Additionally or alternatively, the data in its entirety may be ingested by the AI model(s) 110c where the AI model(s) 110c identifies corresponding voxels, analyzes the first digital map, and correlates the image(s) of each voxel to its respective occupancy status.

Using the ground truth, the AI model(s) 110c may be trained, such that each voxel's visual elements are analyzed and correlated to whether that voxel was occupied by a mass. Therefore, the AI model 110c may retrieve the occupancy status of each voxel (using the first dataset) and use the information as ground truth. The AI model(s) 110c may also retrieve visual attributes of the same voxel using the second dataset.

In some embodiments, the analytics server 110a may use a supervised method of training. For instance, using the ground truth and the visual data received, the AI model(s) 110c may train itself, such that it can predict an occupancy status for a voxel using only an image of that voxel. As a result, when trained, the AI model(s) 110c may receive a camera feed, analyze the camera feed, and determine an occupancy status for each voxel within the camera feed (without the need to use a radar).

The analytics server 110a may feed the series of training datasets to the AI model(s) 110c and obtain a set of predicted outputs (e.g., predicted occupancy status). The analytics server 110a may then compare the predicted data with the ground truth data to determine a difference and train the AI model(s) 110c by adjusting the AI model's 110c internal weights and parameters proportional to the determined difference according to a loss function. The analytics server 110a may train the AI model(s) 110c in a similar manner until the trained AI model's 110c prediction is accurate to a certain threshold (e.g., recall or precision).

Additionally or alternatively, the analytics server 110a may use an unsupervised method where the training dataset is not labeled. Because labeling the data within the training dataset may be time-consuming and may require excessive computing power, the analytics server 110a may utilize unsupervised training techniques to train the AI model 110c.

After the Al model 110c is trained, it can be used by an ego 140 to predict occupancy data of the one or more egos' 140 surroundings. For instance, the AI model(s) 110c may divide the ego's surroundings into different voxels and predict an occupancy status for each voxel. In some embodiments, the AI model(s) 110c (or the analytics server 110a using the data predicted using the AI model 110c) may generate an occupancy map or occupancy network representing the surroundings of the one or more egos 140 at any given time.

In another example of how the AI model(s) 110c may be used, after training the AI model(s) 110c, analytics server 110a (or a local chip of an ego 140) may collect data from an ego (e.g., one or more of the egos 140) to predict an occupancy dataset for the one or more egos 140. This example describes how the AI model(s) 110c can be used to predict occupancy data in real-time or near real-time for one or more egos 140. This configuration may have a processor, such as the analytics server 110a, execute the AI model. However, one or more actions may be performed locally via, for example, a chip located within the one or more egos 140. In operation, the AI model(s) 110c may be executed via an ego 140 locally, such that the results can be used to autonomously navigate itself.

The processor may input, using a camera of an ego object 140, image data of a space around the ego object 140 into an AI model 110c. The processor may collect and/or analyze data received from various cameras of one or more egos 140 (e.g., exterior-facing cameras). In another example, the processor may collect and aggregate footage recorded by one or more cameras of the egos 140. The processor may then transmit the footage to the AI model(s) 110c trained using the methods discussed herein.

The processor may predict, by executing the AI model 110c, an occupancy attribute of a plurality of voxels. The AI model(s) 110c may use the methods discussed herein to predict an occupancy status for different voxels surrounding the one or more egos 140 using the image data received.

The processor may generate a dataset based on the plurality of voxels and their corresponding occupancy attribute. The analytics server 110a may generate a dataset that includes the occupancy status of different voxels in accordance with their respective coordinate values. The dataset may be a query-able dataset available to transmit the predicted occupancy status to different software modules.

In operation, the one or more egos 140 may collect image data from their cameras and transmit the image data to the processor (placed locally on the one or more egos 140) and/or the analytics server 110a, as depicted in the data stream 172. The processor may then execute the AI model(s) 110c to predict occupancy data for the one or more egos 140. If the prediction is performed by the analytics server 110a, then the occupancy data can be transmitted to the one or more egos 140 using the data stream 174. If the processor is placed locally within the one or more egos 140, then the occupancy data is transmitted to the ego computing devices 141 (not shown in FIG. 1A).

Using the methods discussed herein, the training of the AI model(s) 110c can be performed such that the execution of the AI model(s) 110c may be performed locally on any of the egos 140 (at inference time). The data collected (e.g., navigational data collected during the navigation of the egos 140, such as image data of a trip) can then be fed back into the AI model(s) 110c, such that the additional data can improve the AI model(s) 110c.

FIG. 1D shows certain hardware and software components of the ego 140 for performing full or partial self-driving (SD) operations, according to an embodiment. The ego 140 comprises an SD circuit 150 and the ego computing device 141, which may include the same or different components of the SD circuit 150. The SD circuit 150 includes SD chips 152a-152b (generally referred to as SD chip 152), such as system-on-chip (SoC) integrated circuit chips. Each SD chip 152 includes non-transitory machine-readable memories, such as Dynamic Random Access Memories (DRAMs) 190a-190b (generally referred to as DRAMs 190) and SRAMs. The SD chip 152 further includes various types of processing units, including a GPU 191, central processing units (CPUs) 193a-193c (generally referred to as CPUs 193), and specially designed Tera-op, Reliable, Intelligently adaptive Processing System (TRIP) processing units 192a-192b (generally referred to as TRIP units 192).

As mentioned, the ego computing device 141 may execute various software programming operations for managing operations of the SD circuit 150 (or other hardware), which may include execution instructions for applying the neural network architecture on the types of sensor data from the sensors of the ego 140. The operations of the ego computing device 141 may further include, for example, compiling execution instructions for the SD circuit 150 to perform certain functions of the neural network architecture or for operating the ego 140.

In the example embodiment, the SD circuit 150 comprises two SD chips 152a-152b. In many cases, the SD chips 152 function in a redundancy mode or failover mode of operation, where a first SD chip 152a functions as a primary chip and a second SD chip 152b functions as a secondary chip. For example, the first SD chip 152a is prioritized to execute most of the executable instructions, and the second SD chip 152b is invoked to operate as failover or redundancy in the event of problems with the first SD chip 152a.

The ego 140, however, may comprise an SD circuit 150 that operates in an extended compute mode that balances the execution instruction pipelines amongst SD chips 152. As an example, the ego computing device 141 executes software routines for compiling the execution instructions to be performed by the processing units 191-193 of the SD chips 152, and distributing the execution instructions to the optimal hardware components of the SD circuit 150.

In some embodiments, the ego 140 comprises a controller 180 that performs various operations for managing the SD circuit 150. The controller 180 may perform various functions according to, for example, instructions from the ego computing device 141 (or other component of the ego 140) or configuration inputs from an administrative user. For instance, the controller 180 toggles, configures, or otherwise instructs the SD circuit 150 to operate in the various operational modes. In some circumstances, for example, the controller 180 instructs the SD circuit 150 to operate in an extended compute mode in which the first SD chip 152a executes a first instruction partition of the execution instructions and the second SD chip 152b executes a second instruction partition. As another example, in some circumstances, the controller 180 instructs the SD circuit 150 to operate in a failover mode in which the second SD chip 152b executes the execution instructions when the first SD chip 152a fails.

The SD chip 152 includes one or more DRAMs 190 or other types of non-transitory memories for storing data inputs for the SD chip 152. The data inputs may be stored in the DRAM 190 for the processing units to reference for various computations. In some configurations, the TRIP units 192 include SRAMs, such that the SD chip 152 moves the data from a DRAM 190 for storage into the SRAM of the TRIP unit 192. The TRIP unit 192 executes the computation according to the execution instructions and moves the data back to the DRAM 190 or other destination of the SD circuit 150.

The SD chip 152 includes various types of processing units, which may include any hardware integrated circuit (IC) processor device capable of performing the various processes and tasks described herein. Non-limiting examples of the types of processing units include GPUs 191, CPUs 193, TRIP units 192, microcontrollers, ALUs, ASICs, and FPGAs, among others. The processing units may perform the computational functions of the programming layers defining the neural network architectures or sub-architectures. The compilers output the execution instructions representing the operations of the neural network architecture, executed by the ego computing device 141 (or other component of the ego 140).

The TRIP units 192 are designed specifically for the neural network operations, beneficially focusing on improvements to, for example, optimizing power and performance (e.g., low latency). The TRIP units 192 include hardware IC devices (e.g., microcontrollers, ALUs, ASICs, FPGAs, processor devices) designed for fast operations when processing neural network architectures. For instance, as transformers and other types of neural network modeling techniques grow more popular, typical processing units (e.g., CPUs, GPUs) may be unnecessarily slow due to a theory of design intended for broader implementation use cases. For instance, a neural network architecture, sub-neural network, or child neural network performs computer vision or object recognition by implementing various GPTs (or other types of transforms) on the image sensor data, beneficially replacing previous techniques for post-processing of vision neural networks. The TRIP unit 192 is designed specifically for neural network operations allowing the GPT transformers to run natively in the computing components of the ego 140, such that the TRIP units 192 provide faster and more efficient processing than traditional GPUs 191 or CPUs 193 executing similar GPT transformations. In this way, the TRIP units 192 mitigates or eliminates latency and improves overall efficiency, contributing to the ability of the ego 140 to make real-time decisions. Moreover, the structural design and design theory of the TRIP units 192 draw comparatively less power than traditional GPUs 191 or CPUs 193 when performing more sophisticated and complex functions of neural network architectures, such as the transformer networks (e.g., transformers).

The ego computing device 141 may execute software programming defining an execution scheduler 182, which determines which component of the SD circuit 150 should execute which operations of the neural network architecture. During training or inference time, the ego computing device 141 extracts features or tensors from the input sensor data gathered from the sensors of the ego 140, which the ego computing device 141 feeds to the various neural network architecture or sub-architectures for various operations (e.g., computer vision, object recognition). The ego computing device 141 applies a graph partitioner on the sensor data to generate data partitions or portions. The ego computing device 141 applies a set of compilers (not shown), which may logically form a compiler toolchain for the neural network architecture of the ego 140, for compiling and debugging the code for executing layers of the neural network architecture for sensor-data interpretation. Each compiler is used to transform the high-level programming language into machine code comprising execution instructions, executed by the hardware of the SD circuit 150. The compilers may be configured or optimized to compile the programming code according to the specific architectures or types of the processing units (e.g., CPU 193, GPU 191, or specialized TRIP unit 192 hardware) of the SD chips 152. The linker of the execution scheduler 182 may combine multiple compiled pieces of code (e.g., executable instructions) into one or more executable files or data stream for an execution schedule (not shown).

The linker and execution scheduler 182 obtains the set of execution instructions and maps the execution instructions into the hardware components (e.g., GPUs 191, TRIP units 192, CPUs 193) of the SD circuit 150 to perform the particular execution instructions. In some implementations, the linker of the execution scheduler 182 is trained to optimize the operations to be performed in the hardware components of the SD circuit 150. The linker is trained to determine or preconfigured with temporal or latency demands for the hardware components to perform the operations of the execution instructions. This is often possible because such performance-timing or latency metrics are known, essentially static, quickly calculated, or prestored. In this way, the linker maps the execution instructions to the components of the SD circuit 150 according to the minimized or optimized latency. Additionally or alternatively, the linker determines which hardware components of the SD circuit 150 should perform which execution instructions based upon characteristics of the execution instructions (e.g., which compiler generated the machine code of the execution instruction). In this way, the linker maps the execution instructions to the processing units based upon the compiler that generated the particular execution instruction.

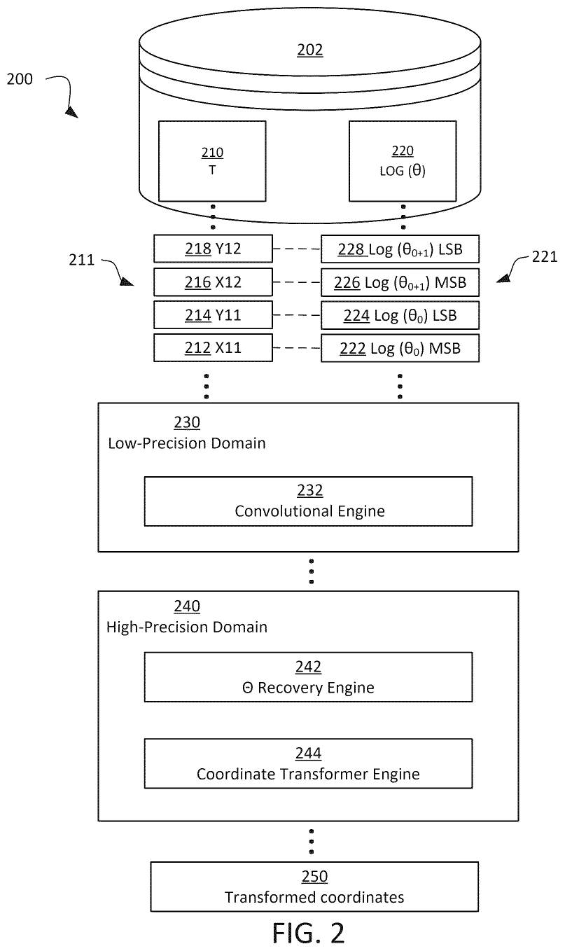

FIG. 2 illustrates an example of a circuit 200 for mixed-precision rotary position embedding, according to some embodiments. The rotary position embedding can be performed incident to an execution of an Al model 110c of an autonomous vehicle 140a, robot 140b, or other ego device 140. For example, an ego computing device 141 can execute the rotary position embedding according to an execution of any of various of the AI models 110c (e.g., for an attention head of a transformer-model).

The circuit 200 includes each of a low-precision domain 230 (including a convolutional engine 232) and a high-precision domain 240 (including a θ recovery engine 242 and a coordinate transform engine 244). These domains can refer to portions of a same die, such as one portion with eight-bit data busses or processing element (e.g., MAC) and another portion, such as an ALU configured to operate on sixteen-bit values. The high-precision domain 240 supports floating point computation, such as may be used to determine trigonometric functions of a rotation matrix. The references to low-and a high-precision are not intended to limit the example to any particular bit-widths, which may themselves vary according to an application or available compute resource. For example, in some embodiments, the low-precision domain may refer to an eight-bit domain and the high-precision domain may refer to a thirty-two-bit domain. In some embodiments, the low-precision domain may refer to a thirty-two-bit domain and the high-precision domain may refer to a sixty-four-bit domain. In further embodiments still, one or more of the low-precision domain or the high-precision domain 240 can be generated according to another compute type (e.g., an analog device).

The circuit includes a data store 202 communicatively coupled with other portions of the circuit 200. The data store 202 stores at least one instance of a tensor, T 210 having a first dimension of a batch size, as second dimension of a sequence length (e.g., a number of tokens in the sequence or multiple thereof), and a dimension of the embeddings. For example, the tensor, T 210 can be iterated or updated according to each forward pass of a transformer or other model. Various tensor elements 211 can have a same bit-width as a bit-width of the low-precision domain 230 or a multiple thereof. The tensor, T 210 can include embedding vectors, Xᵢ which may be represented according to pairs of (Xᵢₗ, Yᵢₗ), (Xᵢₗ, Yᵢₗ) . . . (X_{iD/2}, Y_{iD/2}). The tensor, T 210 can relate to various machine learning model or other data transform, some examples of which are provided above, at FIGS. 1A-1D.

The data store 202 can further include pre-computed instances of a logarithm of various angles, θ. The precomputed values can correspond to all values (e.g., all values between zero and pi (or 180°)) such that a non-linear representation (e.g., logarithm) of any angle can be retrieved. Such a retrieval is according to a pre-computed granularity, in some embodiments. The pre-computed instances of the logarithm can refer to a logarithm of base₂, base₁₀, or baseₑ (i.e., a natural log). The pre-computed instances may be computed according to a precision in excess of a bit-width of the low-precision domain 230. For example, the pre-computed instances may be computed according to a multiple of a bit-width of the low-precision domain 230, wherein a sub-portion of a precomputed instance and alternating tensor elements 211 are multiplied with a predefined value to deliver the values to a register at an output of a component executing the multiplication function. For example, the tensor elements or logarithms can be multiplied by one to deliver the values as received, or a power of two to left-shift the values in an output register for a component implementing the multiplication function. In some embodiments, the pre-computed values can be computed according to an e^{-x} function (e.g., in a complex plane).

In some embodiments, the logarithm of the various angles, θ may be computed live or otherwise derived (e.g., from a high-precision domain 240 or an external data source). However, the inclusion of the precomputed values can reduce computational demand in systems having sufficient storage space and lacking available compute resources to generate the values. A low-precision domain 230 can receive the various tensor elements 211 at a bit-width corresponding to circuitry of a convolutional engine 232 of the low-precision domain 230. For example, the tensor elements 211 can include a first pair of an X coordinate, X₁₁ 212 and Y coordinate, Y₁₁ 214, and a second pair of an X coordinate, X12 216 and Y coordinate, Y12 218.

The low-precision domain 230 can receive at least a portion of the precomputed instances of the logarithms of an ingested angle (e.g., a portion equal to a bit-width of the various tensor elements 211). Such portion may be referred to as low-precision logarithm portions 221. The depicted examples of the low-precision logarithm portions 221 include an MSB 222 and LSB 224 pair of a logarithm of a first angle, θ and an MSB 226 and LSB 228 pair for a subsequent angle (e.g., an angle of a subsequent rotation). In some embodiments, the logarithms of the angles may be provided according to wider or narrower bit-widths (e.g., eight-bits or thirty-two-bits).

The various of the tensor elements 211 and the low-precision logarithm portions 221 may be ingested into the low-precision domain 230 as paired sets, so that each of the tensor elements 211 corresponds to one of the low-precision logarithm portions 221. The low-precision logarithm portions 221 can be repeated where a number of tensor elements 211 exceeds a number of low-precision logarithm portions 221. For example, a tensor including sixteen eight-bit clement can be paired with eight identical instances of the two eight-bit low-precision logarithm portions 221. However, in general, as is depicted, updated low-precision logarithm portions 221 can be provided for each pair. In some embodiments, the circuit 200 is configured to provide such an update in alignment with a transition to an updated instance of the tensor, T 210 or a pair thereof. That is, θ can be updated for each paired set based on a result of a previous set or other rotational instruction (e.g., wherein the transformed coordinates define or are related to a subsequent value of θ, θ′).

Various engines, such as the depicted example of a convolutional engine 232, can operate on tensors 211 in the low precision domain 230. For example, the convolutional engine 232 can multiply and accumulate the tensor elements 211 and the low-precision logarithm portions 221. The convolutional engine 232 can be implemented according to a hardware MAC having a bit-width equal to the bit-width of the tensor elements 211 and the low-precision logarithm portions 221, to generate an output having twice such a bit-width (e.g., an eight-bit MAC configured to generate a sixteen-bit product, which can include, for example, a left-shifted or unity instance of an input). That is, the convolutional engine 232 can employ the MAC as an accumulator to accumulate a sixteen-bit value from multiple eight-bit values rather than performing a convolution (e.g., the combination of the MSB and the LSB for log(θ) or an X/Y pairs of eight-bit low-precision logarithm portions 221). The use of the convolutional engine 232 can perform operations not supported in the high-precision domain 240, or which are resource constrained, such that a total throughput can be increased. In some applications, such as latency sensitive or throughput sensitive applications (e.g., computer vision systems of an ego 140 such as a robot 140a or an autonomous vehicle 140c, as implemented with an ego computing device 141 thereof), such an implementation can aid in using the data for a perception or autonomy system. For example, where the tensor T 210 is derived from or otherwise based on real-time sensor data, the increased throughput and decreased latency realized according to the application of the present disclosure can aid a vehicle to generate control signals to execute a navigational action such as a change in speed or direction (e.g., object avoidance).

The circuit 200 can convey the products to a θ recovery engine 242 of the high-precision domain 240 to recover theta (e.g., to negate the application of the use of the log of θ instead of θ itself in the low-precision domain 230). For example, the circuit 200 can generate an exponent of the ingested values to recover θ. Using the recovered value of θ, a coordinate transform engine 244 can generate transformed coordinates 250 for a n+1^{th} rotation, and can output the transformed coordinates 250. For example, the coordinate transform engine 244 can determine trigonometric functions of the recovered angle, θ, to determine the transformed coordinates 250.

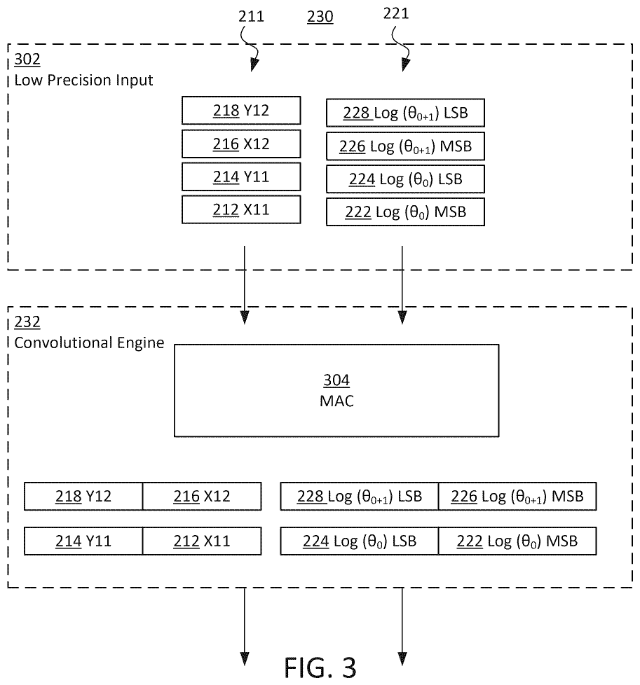

FIG. 3 illustrates an example block diagram of a low-precision domain 230 of a circuit 200 for rotary position embedding, according to some embodiments. The convolutional engine 232 can receive fixed bit-width values (e.g., eight-bit values) at a low-precision input 302. For example, the tensor elements 211 and the low-precision logarithm portions 221 can be received at the low-precision input 302 for ingestion into a component configured to execute a multiplication function, which may include a fix-bit function. The convolutional engine 232 can include a MAC 304 configured to convolve across the two input values (e.g., employing alternating kernels [0 1] bytes and [1 0] bytes to interleave an input received from the tensor elements 211 and the low-precision logarithm portions 221, respectively). Accordingly, the convolutional engine 232 can provide a product of an output (e.g., where the product is used to left-shift bits by multiplying by powers of two, or as a filter by multiplying by inputs of 0b0000_0000 or 0b1111_1111).

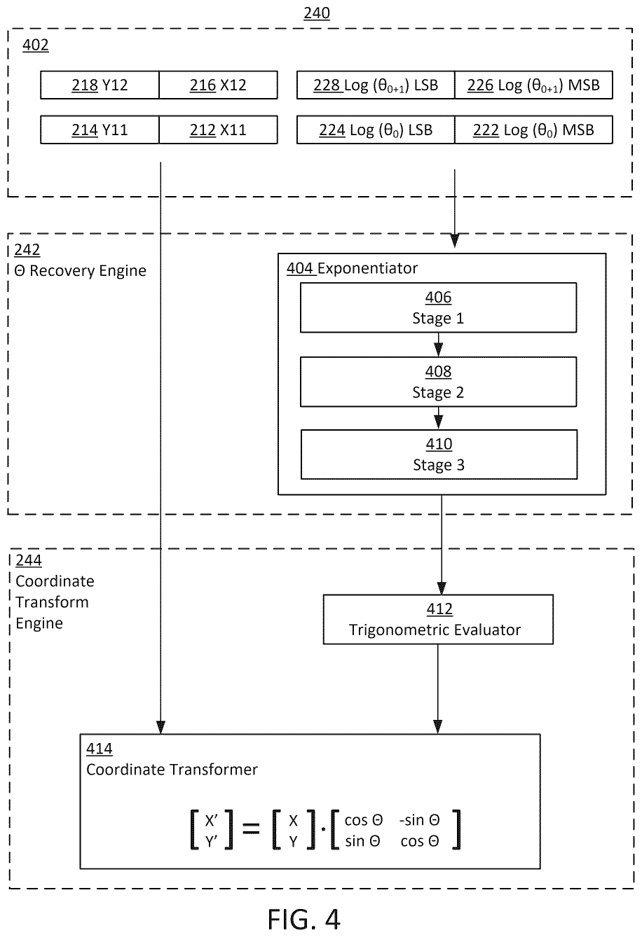

FIG. 4 illustrates an example block diagram for a high-precision domain 240 of a circuit for rotary position embedding, according to some embodiments. The high-precision domain 240 can receive fixed bit-width values (e.g., sixteen-bit values) at a high-precision input 402. For example, the high-precision input 402 can receive a concatenation of the X/Y pairs (e.g., a first element including the first pair of X coordinate, X11 212 and Y coordinate, Y11 214, and second clement including the second pair of X coordinate X12 216 and Y coordinate Y12 218). The high-precision input 402 can receive a third element including (e.g., concatenating) the MSB 222 and LSB 224 pair of a logarithm of a first angle, θ and a fourth element likewise including an MSB 226 and LSB 228 pair for a subsequent angle. The high-precision input 402 can convey the (concatenated) tensor elements 211 to at least the coordinate transform engine 244, and the (concatenated) logarithm portions 221 to at least the θ recovery engine 242.

An exponentiator 404 of the θ recovery engine 242 can exponentiate the (e.g., sixteen-bit) values of θ to negate the prior logarithm. Although the exponentiation accrues some quantization error, the transport of the log of the angle may reduce overall error (e.g., because the dynamic range of the log of the angle is substantially less than the angle itself). Further, the quantization error may be more uniform. Thus, applying the logarithm for data transport can decrease a total amount of data throughout through a system, wherein the θ recovery engine 242 can restore the value with sufficient precision for autonomous vehicle navigation, or other machine vision applications such as robotic motion planning.

The θ recovery engine 242 can exponentiate the received values of log(θ) according to various techniques, such a look up table (LUT), range reduction or polynomial approximation, coordinate rotation digital computer (CORDIC) algorithm, or Taylor-series approximation. For example, a Taylor-series expansion can be approximated according to a desired level of precision (e.g., a first three, four, or five elements). In some embodiments, the expansion may be performed natively (e.g., in a thirty-two or sixty-four bit ALU). In some embodiments, the expansion may be approximated, such as according to Horner's method. For example, at a first stage 406, a multiplier can multiply an input by ⅓, and an adder can add one to the result. At a second stage 408, the multiplier can multiply an input by the result of the first stage 406 and add one-half. At a third stage 410, the multiplier can multiply an input by the result of the second stage 408 and add 1. An output stage can multiply the result of the third stage 410 by one and add one to the result. The various stages may be executed by various MACs 304 or a MAC array, in some embodiments. Such an illustrative example of an implementation should not be construed as limiting.

An output of the θ recovery engine 242 can be provided to a trigonometric evaluator 412 to determine a sine and cosine thereof. In some embodiments, the coordinate transform engine 244 can employ a trigonometric evaluator 412 to determine the values according to a same object recognition engine related technique (e.g., same hardware components of an ALU) as the exponentiator 404 (e.g., a LUT, or Taylor series expander or approximation thereof). In some embodiments, the trigonometric evaluator 412 can determine the trigonometric functions (e.g., sine and cosine) according to a different technique from the exponentiator 404.

An output of the trigonometric evaluator 412, along with the other inputs can be provided to a coordinate transformer 414 to determine transformed coordinates 250 according to the application of a rotation matrix as follows:

$$\begin{matrix}{X}^{′} \\ {Y}^{′}\end{matrix} = [ \begin{matrix}X \\ Y\end{matrix} ] \cdot [ \begin{matrix}cos ( θ ) & - sin ( θ ) \\ sin ( θ ) & cos ( θ )\end{matrix} ] .$$

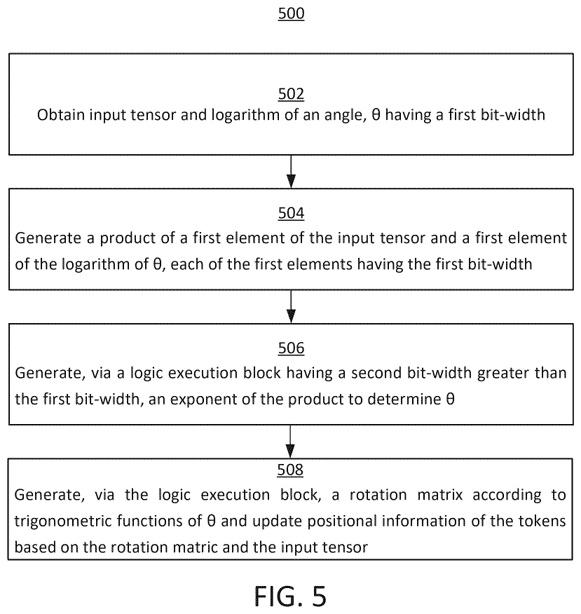

FIG. 5 illustrates an example of a method 500 for rotary position embedding, according to some embodiments. The method 500 can be performed by a mixed-precision pipeline which includes one or more circuits of a compute device (e.g., ego computing devices 141a-141c). The one or more circuits can include a circuit for implementing a multiplication function (e.g., a MAC of a MAC array configured to convolve kernels including weights across a data structure representing one or more layers of a machine learning model). The one or more circuits can include an arithmetic logic unit (ALU). For example, the ALU can include a multiplier or other components configured to operate at a wider bit-width than the MAC or other circuit implementing the multiplication function, which may be a fixed-bit function.

At operation 502, the circuit obtains an input tensor and a logarithm of an angle, θ. For example, the input tensor may be received according to a serial stream or parallel transfer (e.g., register transfer). The circuit can obtain each of the input tensor and the logarithm of θ at an input of a MAC (or other circuit implementing the multiplication function according to a fixed bit-width equal to the first bit-width). The input tensor can include a sixteen-element tensor of paired X and Y elements, each of the elements having a bit-width equal to half of the bit-width of a discretized value of log(θ) (e.g., eight-bit tensor values and sixteen-bit log values). The value of log(θ) can be computed at runtime, or be pre-computed and stored. Such pre-computation may reduce runtime-compute demand, particularly so where the value of log(θ) is stored according to relatively large bit-width, such as a greater bit-width than the MAC input or other circuit implementing the multiplication function (even if the value is stored according to a bit-value which is less than other portions of a device, such as the ALU). In some cases, a pre-computed value of the logarithm is stored according to a greater bit-width than the MAC and a lesser bit-width than the ALU. Moreover, where each paired set of tensor elements (in combination) have a same bit-width as the log(θ), the circuit can interleave input of one or the other of the paired set of tensor elements with a first and second element of log(θ) (e.g., as retrieved from the storage location for pre-computed values).

At operation 504, the circuit generates, using a multiplication function of the circuit for inputs having the first bit-width, a product of a first element of the input tensor and a first element of the logarithm of θ, each of the first elements having the first bit-width. For example, the multiplication function can multiply a predefined value with each of the first element of the input tensor and the first element of the logarithm of θ. In some embodiments, the predefined values are equal to one, so as to cause the products to equal the input multiplicands (e.g., the first element of the input tensor and the first element of the logarithm of θ). In some embodiments, the predefined values are equal to a power of two (e.g., 128 or 256, for an eight-bit value), so as to left shifted the product, relative to the multiplicand. That is, the MAC or other component implementing the multiplication function can operate as either of a data bus or a shift register.

In some embodiments, the circuit can further generate, using the multiplication function, a product of a second element of the input tensor and a second element of the logarithm θ, each of the second elements having the first bit-width. In some embodiments, a multiplicand used to generate the products for each of the second element of the input tensor and the second element of the logarithm is a power of two (e.g., 128 or 256) and a multiplicand used to generate the products for each of the first element of the input tensor and the first element of the logarithm is one. The left-shifted second element of the input tensor and first element of the input tensor can be stored into a same output word in an adder, accumulator, or other register of a MAC or at an output thereof. Similarly, the left-shifted second element of the first element of the logarithm can be stored into a same output word in an adder, accumulator, or other circuit of a MAC or at an output thereof. Thus, the MAC can concatenate inputs to provide outputs having twice an input bit-width for an ALU.

At operation 506, the ALU generates an exponent of the product to determine θ according to the second bit-width. The ALU operational bit-width can exceed the bit-width of the MAC (and the bit-width of the logarithm of θ, in some environments) and may sometimes be referred to as existing in a high-precision domain. Accordingly, although the angle of θ may exhibit greater dynamic range than the logarithm (and may contribute quantization error additive to any quantization error of the quantization layer of the log of θ), the wider bit-width of the ALU, relative to other components of a system implementing the present operation can lower discretization error, relative to other techniques (e.g., where the circuit obtains a linear indication of θ). As indicated above, the ALU can exponentiate the ingested logarithmic angles according to various techniques, such as a LUT including high-precision values (e.g., thirty-two or sixty-four bits), series expansion or approximation thereof, or other techniques. Some such techniques may be relatively computationally expensive, but can increase overall system performance according to throughput increases related to the lower-bit transference of the values for log(θ) as input into the circuit, and throughout a system.

At operation 508, the ALU generates a rotation matrix according to trigonometric functions of θ. For example, the ALU can calculate a sine and cosine of theta θ according to a Taylor series expansion or other operation. The ALU then updates positional information for the circuit based upon the rotation matrix and one or more elements of the input tensor. Some of the operations to determine the trigonometric functions of θ may overlap with the exponentiation of operation 506, and, accordingly, may be implemented on same components of the ALU (or otherwise in the circuit). However, such an illustrative example should not be construed as limiting; some embodiments, can include components of a different type to execute operations 506 and 508, or can include a same type of component allocated for separate purposes, as in the case of a static or dynamic pipelined operation within one or more ALUs executing the present method. The ALU can generate, based on at least the first element of the input tensor and the rotation matrix, transformed coordinates. For example, the ALU can multiply a first matrix of the paired first and second elements of the input tensor with the rotation matrix to generate the transformed coordinates.

In some embodiments, the method can further include storing the transformed coordinates at a storage location by the ALU or another component coupled therewith. The storage location may be read-accessible to a component of a data pipeline and the component being disposed downstream of a MAC implementing the multiplication function and the arithmetic logic unit. In some embodiments, the storage location is not read-accessible by the arithmetic logic unit, and is not write-accessible by the downstream component. According to a rotation determined according to the transformed coordinates, the execution of the method can encode positional information into input embeddings of a transformer model based on the rotation matrix.

Another method for audio data processing is provided, according to some embodiments. The method can be performed by a mixed-precision pipeline which includes one or more circuits of a compute device (e.g., ego computing devices 141a-141c). The one or more circuits can include a circuit for implementing a multiplication function (e.g., a MAC of a MAC array configured to convolve kernels including weights across a data structure representing one or more layers of a machine learning model). For example, the circuit can include the low-precision domain 230 or the high precision domain 240 of the circuit 200 of FIGS. 2-4. Accordingly, the one or more circuits can include an arithmetic logic unit (ALU) having a multiplier or other components configured to operate at a wider bit-width than the MAC or other circuit implementing the multiplication function. In some cases, the multiplication function is a hardware-limited fixed-bit function of the MAC or other hardware components.

The method of operating the circuit can aid in the processing of audio data, such as audio data of an environment surrounding an ego vehicle (e.g., egos 140a-b). For example, some audio processing can include a generation of a short-time Fourier transform (STFM). The STFM can indicate content present in a duration-limited capture. For example, a horn can be represented by a relatively small number of peaking frequencies in the frequency domain (e.g., about 400 Hz), while an automobile collision can be indicated by a relatively broadband frequency domain (e.g., corresponding to a time-domain Dirac function at the time of impact). An autonomous vehicle can navigate an environment based on various transforms of the audio data, such as melody (mel) spectrograms (or other data, such as video data, or data in other state spaces, such as a state space for a RoPE).

To determine a log mel spectrogram of the audio data, weights of the STFT can be selected, followed by an extraction of real and imaginary components according to an execution of a convolutional operation. A power spectrogram can be determined according to a squared magnitude of the real and imaginary components. The power spectrogram can be multiplied by a mel filter bank. A logarithm of that product can generate the log mel spectrogram, as indicated below in Example 1. However, where the convolution operation is performed by a low-precision component (e.g., an 8-bit MAC), substantial discretization error may be incurred prior to applying the log transform, or an exponentiation. That is, even where low precision data would be useful, as represented in the log transform, substantial information loss incurred prior to the transform can render the data irrecoverable by the circuit. As is depicted in Example 2, below, the convolutional processes can be applied with lower-precision hardware with reduced discretization error, relative to Example 1.

### EXAMPLE 1

Weights of an STFT can be provided as a Vandermonde Matrix. For example, some sample instructions follow:

def dft_matrix (self , n):
(x, y) = np. meshgrid (np. arange (n), np. arange (n))
omega = np. exp (−2 * np.pi * 1j / n)
W = np. power (omega , x * y) # shape: (n, n)
return W

The execution of the STFT can be executed to determine imaginary and real parts. However, substantial discretization error can be incurred when such an operation is performed in a reduced precision domain, such as the low-precision domain 230 of FIG. 2. Conversely, where a MAC or other convolutional hardware is not available, performance of the convolution can prove insufficient for autonomous driving, machine vision, audio processing, or other real-time applications. For example, an FFT window size can be provided as 1024, and a hop length can be provided as 256, leading to substantial computational expense impractical for a general purpose ALU. An example of some sample instructions for STFT execution follows:

```
  self.conv_real = nn. Conv1d (in_channels =1, out_channels = out_channels,
kernel_size =n_fft , stride = self . hop_length , padding =0, dilation =1, groups =1, bias =
False )
  self . conv_imag = nn. Conv1d ( in_channels =1, out_channels = out_channels,
kernel_size =n_fft , stride = self . hop_length , padding =0, dilation =1, groups =1, bias =
False )
  # Initialize Conv1d weights.
  self.conv_real.weight.data = torch . Tensor (np. real ( self .W[:, 0 : out_channels ] *
fft_window [:, None ]). T)[: , None , :]. contiguous ( )
  # (n_fft // 2 + 1, 1, n_fft)
  self . conv_imag . weight . data = torch . Tensor (np. imag ( self .W[:, 0 : out_channels
] * fft_window [:, None ]). T)[: , None , :]. contiguous ( )
  # (n_fft // 2 + 1, 1, n_fft)
```

Using the resolved real and imaginary portions, the log-mel spectrum can be obtained as follows:

```
  def logmelspectrogram (x)
  real = self . conv_real (x)
  imag = self . conv_imag (x)
  spectrogram = real ** 2 + imag ** 2
  # spectrogram shape (*, n_fft // 2 + 1)
  # melW shape (n_fft // 2 + 1, mel_bin)
  # Mel spectrogram
  mel_spectrogram = torch . matmul ( spectrogram , self . melW)
  # (*, mel_bins)
  # Logmel spectrogram
  output = log( mel_spectrogram)
return output
```

According to the above, even where the log mel spectrogram is aligned to the precision of corresponding hardware (e.g., log uniform data), intermediate operations can lose information to discretization error, relative to the approach of Example 2, provided henceforth.

### EXAMPLE 2

A single output index of a convolution can be provided as oᵢⱼ, that is:

$${\sum }_{k} {s}_{ik} {m}_{k j} = log ( {\sum }_{k} ( {r}_{ik}^{2} + {i}_{ij}^{2} ) {m}_{kj} ) ,$$

where s is the spectrogram and m is the mel matrix. Such an expression can be provided, alternatively, as:

$$log ( {\sum }_{k} exp ( log ( {r}_{ik}^{2} {m}_{kj} ) ) + exp ( log ( {i}_{ik}^{2} {m}_{k j} ) ) ) ; or$$

$$log ( {r}_{ik}^{2} * {m}_{kj} ) + log ( {i}_{ij}^{2} * {m}_{kj} ) = log ( {( {r}_{ik} {\sqrt{m}}_{kj} )}^{2} ) + log ( {( {i}_{ij} {\sqrt{m}}_{kj} )}^{2} ) .$$

Such a representation maintains the logarithmic form, such that log-normal data can be maintained. For mel weights of a shape (n_{fft}/2, Melbin), the matrix can be stacked (e.g., duplicated) to form shape (n_{fft}, Melbin). The above can be transposed and square rooted to generate the expression:

$${w}_{mel} = \sqrt{cat ( self \cdot melW , self \cdot melW , dim = 0 ) \cdot transpose} ( )$$

Such values can be multiplied with the real and imaginary convolutional weights and stacked into a single convolutional term. The intermediate rᵢₖ(Mₖⱼ)^{.5} can be determined by a single convolution and a fused log²(x)=2 log(x) can be performed according to parallel computation in a reduced precision domain. For example, outputs of the convolution can be provided as follows, based on the inputs received via a same input as the tensor elements 211 and low-precision logarithm portions 221 above (e.g., by an 8-bit MAC). The outputs of the convolution can appear as follows:

$$log ( {( {r}_{11} √ {m}_{11} )}^{2} ) log ( {( {r}_{21} √ {m}_{12} )}^{2} ) ⋯$$

$$log ( {( {i}_{11} √ {m}_{11} )}^{2} ) log ( {( {r}_{21} √ {m}_{12} )}^{2} ) ⋯$$

$$log ( {( {r}_{12} √ {m}_{21} )}^{2} ) log ( {( {r}_{21} √ {m}_{12} )}^{2} ) ⋯$$

$$log ( {( {i}^{12} \sqrt{{m}^{21}} )}^{2} ) log ( {( {r}^{21} \sqrt{{m}^{12}} )}^{2} ) ⋯$$

$$⋮ ⋮ ⋱$$

Parallel operations (e.g., logsumexp) can be applied to these outputs to realize a higher precision result, relative to Example 1.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers.

Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for encoding position information in a mixed-precision pipeline comprising:
obtaining, via a circuit for a first bit-width, an input tensor and a logarithm of an angle, θ;
generating, by a multiplication function of the circuit for inputs having the first bit-width, a product of a first element of the input tensor and a first element of the logarithm of the angle θ, each of the first elements having the first bit-width;
generating, via a logic execution block having a second bit-width greater than the first bit-width, an exponent of the product to determine the logarithm of the angle θ according to the second bit-width;
generating, via the logic execution block, a rotation matrix according to trigonometric functions of the logarithm of the angle, θ; and
updating, via the logic execution block, positional information of tokens for the circuit based upon the rotation matrix and one or more elements of the input tensor.

2. The method of claim 1, further comprising generating, using the multiplication function of the circuit, a product of a second element of the input tensor and a second element of the logarithm of the logarithm of the angle θ, each of the second elements having the first bit-width.

3. The method of claim 2, further comprising obtaining, from a storage location for pre-computed values, the first element and second element of the logarithm of the angle, θ.

4. The method of claim 2, further comprising generating, based on the first element of the input tensor and the rotation matrix, transformed coordinates.

5. The method of claim 4, further comprising storing the transformed coordinates at a storage location, the storage location read-accessible to a component of a data pipeline and the component being disposed downstream of a MAC implementing the multiplication function and the logic execution block.

6. The method of claim 5, wherein the storage location is not read-accessible by the logic execution block, and is not write-accessible by the downstream component.

7. The method of claim 6, further comprising encoding the positional information into input embeddings of a transformer model based on the rotation matrix.

8. The method of claim 1, wherein the multiplication function is a hardware-limited fixed-bit function of a multiplier-accumulator (MAC).

9. The method of claim 8, wherein a pre-computed value of the logarithm of the angle θ is stored according to a greater bit-width than the MAC and a lesser bit-width than the logic execution block.

10. A system for encoding position information in a mixed-precision pipeline, the system comprising:
a circuit for a first bit-width, the circuit configured to:
execute a multiplication function for inputs having the first bit-width;
obtain a first set of values and a second set of values; and
generate, using the multiplication function, a product of a first element of the first set of values and a first element of the second set of values, each of the first elements having the first bit-width; and
a logic execution block having a second bit-width greater than the first bit-width, the logic execution block configured to:
generate an exponent of the product to determine an output according to the second bit-width; and
generate output data based on the exponent of the product.

11. The system of claim 10, wherein the circuit is configured to:
generate, using the multiplication function, a product of a second element of an input tensor and a second element of a logarithm θ, each of the second elements having the first bit-width;
generate an exponent of the product to determine the logarithm θ according to the second bit-width;
generate a rotation matrix according to trigonometric functions of the logarithm θ; and
update positional information of tokens for the circuit based upon the rotation matrix and one or more elements of the input tensor,
wherein the first set of values comprise the input tensor and the second set of values comprise the logarithm of the logarithm θ.

12. The system of claim 11, wherein the system is configured to provide, from a storage location for pre-computed values and to the circuit, the first element and second element of the logarithm θ.

13. The system of claim 11, wherein the logic execution block is configured to generate, based on the first element of the input tensor and the rotation matrix, transformed coordinates.

14. The system of claim 13, wherein the logic execution block is configured to store the transformed coordinates at a storage location, the storage location read-accessible to a component of a data pipeline, the component disposed downstream of both a multiplier-accumulator (MAC) implementing the multiplication function and the logic execution block.

15. The system of claim 14, wherein the storage location is not read-accessible by the logic execution block, and is not write-accessible by the downstream component.

16. The system of claim 15, wherein the system is configured to generate, using the rotation matrix, input embeddings of a transformer model comprising the positional information.

17. The system of claim 10, wherein the multiplication function is a hardware-limited fixed-bit function of a multiplier-accumulator (MAC), the multiplication function configured to generate products having the second bit-width from first second multiplicands having the first bit-width.

18. An autonomous vehicle comprising:
one or more sensors configured to generate an input data structure having a plurality of data elements which exceed a first bit-width and are equal to a second bit-width, and including natural numbers;
a circuit for the first bit-width, the circuit configured to:
execute a multiplication function for inputs having the first bit-width;
obtain an input tensor and a logarithm of an angle, θ; and
generate, using the multiplication function, a product of a first element of the input tensor and a first element of the logarithm of the angle θ, each of the first elements having the first bit-width; and
an logic execution block having the second bit-width greater than the first bit-width, the logic execution block configured to:
generate an exponent of the product to determine the logarithm of the angle θ according to the second bit-width; and
generate a rotation matrix according to trigonometric functions of the logarithm of the angle θ.

19. The vehicle of claim 18, wherein the circuit is configured to generate, using the multiplication function, a product of a second element of the input tensor and a second element of the logarithm θ, each of the second elements having the first bit-width, and
wherein the logic execution block is configured to generate, based on the first element of the input tensor and the rotation matrix, transformed coordinates.

20. The vehicle of claim 19, wherein the logic execution block is configured to store the transformed coordinates at a storage location, the storage location read-accessible to a component of a data pipeline, the component disposed downstream of both a multiplier-accumulator (MAC) implementing the multiplication function, and the logic execution block, and
wherein the storage location is not read-accessible by the logic execution block, and is not write-accessible by the downstream component.
